(19) United States
(12) Patent Application Publication
(10) Pub. No.: US 2007/0113477 A1
(43) Pub. Date: May 24, 2007

(54) Window glass, window glass electrode leading-out device, window glass conductivity-adding method, and a window glass electrode leading-out method

(75) Inventors: Yoshimitsu Matsushita, Tokyo (JP); Toru Maruyama, Tokyo (JP); Hideki Okamoto, Tokyo (JP); Kazuhisa Ono, Tokyo (JP); Yasukazu Kanatani, Tokyo (JP)

Correspondence Address: COHEN, PONTANI, LIEBERMAN & PAVANE, 551 FIFTH AVENUE, SUITE 1210, NEW YORK, NY, 10176, US

(73) Assignee: Nippon Sheet Glass Company, Limited, Tokyo (JP)

(21) Appl. No.: 11/598,901

(22) Filed: Nov. 14, 2006

(30) Foreign Application Priority Data
Nov. 14, 2005 (JP) 2005-329445

(51) Int. Cl. E05F 15/02

(52) U.S. Cl. 49/27

(57) ABSTRACT

A window glass which makes it possible to realize an excellent appearance thereof at low costs. The window glass is moved upward and downward by a window regulator. The window glass comprises a portion defining a curved recess formed in an upper end face of the window glass such that it has a maximum depth of 0.2 to 5.0 mm and a width of 0.5 to 4.5 mm, and an electrode part formed of a conductive material injected into the curved recess.

### BACKGROUND OF THE INVENTION

1. Field of the Invention

The present invention relates to a window glass, a window glass electrode leading-out device, a window glass conductivity-adding method, and a window glass electrode leading-out method, and more particularly to a window glass that is moved upward and downward by a window regulator, a window glass electrode leading-out device for leading out an electrode from an electrode part formed in an upper end face of the window glass that is moved upward and downward by the window regulator, a window glass conductivity-adding method of adding conductivity to the window glass that is moved upward and downward by the window regulator, and a window glass electrode leading-out method of leading out the electrode from the electrode part formed in the upper end face of the window glass that is moved upward and downward by the window regulator.

2. Description of the Related Art

In a conventional window regulator, torque of a motor is transmitted to a drum via gears, and an entire wire is moved by rotation of the drum, whereby a window glass connected to the wire via holders and brackets is moved vertically. In this case, vertical movement of the window glass is realized by switching the direction of rotation of the motor between normal rotation and reverse rotation.

Further, the conventional window regulator includes a type which is provided with a safety device for preventing a human neck or hand from being caught between the window glass and a window frame during upward movement of the window glass.

This safety device detects occurrence of a catching accident by sensing the rotational speed of the motor and pressure applied to the window glass, to stop or lower the window glass. However, there is a case where slight contact of a human neck or hand with the window glass does not apply pressure high enough to be sensed by the safety device, and hence in this case, the motor cannot be stopped promptly enough to prevent a catching accident.

To solve this problem, there has been proposed a safety device which is capable of determining, based on a change in capacitance, whether or not any object (e.g. a portion of a human body) other than air, which has a large dielectric constant, is present between the window glass and the window frame, to thereby detect a state which can cause a catching accident (i.e. possibility of occurrence of a catching accident) before the window glass comes into contact with the object, and causing a driving means to stop or reverse rotation of the associated motor. In this safety device, a first electrode part is disposed on an upper end of the window glass such that it covers a gap formed between the window glass and the glass frame when the window glass is lowered, and a second electrode part, which is provided on a vehicle body side, is disposed in a glass run of the window frame, whereby a capacitor is formed between the first electrode part and the second electrode part. In this safety device, a window glass electrode part 71 as the first electrode part is formed by providing some conductive substance on the upper end of the window glass, and is connected to a measurement voltage generating circuit 72 (FIG. 7)(see e.g. Japanese Laid-Open Patent Publication (Kokai) No. H10-110574).

Further, there have already been proposed a window glass electrode part formed by embedding an electrode in a window glass during manufacturing of the window glass (reference numeral 80 in FIG. 8)(see e.g. Japanese Laid-Open Patent Publication (Kokai) No. S60-070622), a window glass electrode part provided on a side surface of a window glass (reference numeral 90 in FIG. 9)(see e.g. Japanese Laid-Open Patent Publication (Kokai) No. S57-209382, and International Publication No. WO99/63192), and a window glass electrode part affixed to a window glass such that the electrode part extends along an upper end of the window glass (reference numerals 100 and 101 in FIG. 10) (see e.g. Japanese Laid-Open Patent Publication (Kokai) Nos. H11-334359 and H11-036709).

Further, there have already been proposed an arrangement in which a touch sensor 113 having a pair of electrode parts 114 and 114a fixed to an upper end of a window glass 112 by baking, as shown in FIG. 11, a piezoelectric sensor, or the like is disposed in a recess 112a formed in the upper end of the window glass 112 (see e.g. Japanese Laid-Open Patent Publication (Kokai) Nos. S60-119883 and 2001-115738), and an arrangement in which a piezoelectric sensor 122 is mounted in an upper end of a window glass 121 via a shock absorbing member 123 as shown in FIG. 12 (see e.g. Japanese Laid-Open Patent Publication (Kokai) No. H10-076843), in place of the arrangement in which some conductive substance is provided as the window glass electrode part on the upper end of the window glass.

However, it is difficult to form an electrode part excellent in appearance in the window glass at low costs. In the above-mentioned patent documents, the method of forming an electrode part of the window glass by affixing, applying, or printing the conductive substance at a predetermined location of the window glass is described, but no detailed description is given of a method of forming an electrode part excellent in appearance in the window glass at low costs.

In the above-mentioned patent documents, an electrode leading-out device which leads out an electrode from an electrode part formed in a window glass and an electrode leading-out method are not described, either.

### SUMMARY OF THE INVENTION

It is an object of the present invention to provide a window glass, a window glass electrode leading-out device, a window glass conductivity-adding method, and a window glass electrode leading-out method, which make it possible to realize an excellent appearance and reduced costs.

To attain the above object, in a first aspect of the present invention, there is provided a window glass that is moved upward and downward by a window regulator, comprising a portion, defining a recess, that is formed in an upper end face of the window glass such that the recess has a maximum depth of 0.2 to 5.0 mm and a width of 0.5 to 4.5 mm, and an electrode part that is formed of a conductive material injected into the recess.

With the arrangement of the window glass according to the first aspect of the present invention, it is possible to realize an excellent appearance and reduced costs.

Preferably, the recess comprises a groove formed on and along the upper end face of the window glass.

Preferably, the recess is formed by grinding the upper end face of the window glass using a diamond wheel having a projecting part.

With the arrangement of this preferred embodiment, it is possible to form a recess excellent in appearance at low costs.

More preferably, the conductive material is injected into the recess using a nozzle having a tip end having an inner diameter of 1 to 2 mm.

With the arrangement of this preferred embodiment, it is possible to form an electrode part excellent in appearance at low costs.

To attain the above object, in a second aspect of the present invention, there is provided a window glass that is moved upward and downward by a window regulator, the window glass having an upper end face thereof ground into a generally semi-circular shape, comprising a covering member that is formed of a conductive material, and is mounted, as an electrode part, along the upper end face ground into the generally semi-circular shape.

With the arrangement of the window glass according to the second aspect of the present invention, it is possible to form an electrode part excellent in appearance at low costs.

Preferably, the covering member is formed using a roll forming process.

With the arrangement of this preferred embodiment, it is possible to easily produce a covering member matching the shape of an end of the window glass.

To attain the above object, in a third aspect of the present invention, there is provided a window glass that is moved upward and downward by a window regulator, comprising an electrode part that is formed of a conductive material, the electrode part being formed on an upper end face of the window glass by an inkjet method.

With the arrangement of the window glass according to the third aspect of the present invention, it is possible to realize an excellent appearance and reduced costs.

To attain the above object, in a fourth aspect of the present invention, there is provided a window glass electrode leading-out device for leading out an electrode from an electrode part formed in/on an upper end face of a window glass that is moved upward and downward by a window regulator, comprising a terminal that is connected to the electrode via a conductive adhesive.

With the arrangement of the window glass electrode leading-out device according to the fourth aspect of the present invention, it is possible to realize an excellent appearance and reduced costs.

To attain the above object, in a fifth aspect of the present invention, there is provided a window glass electrode leading-out device for leading out an electrode from an electrode part formed in/on an upper end face of a window glass that is moved upward and downward by a window regulator, comprising a portion, defining a through hole, that is formed through the window glass at a location close to the upper end portion of the window glass, a conductive part in a clip shape that is electrically connected to the electrode part, hook parts which are provided at the opposite ends of the conductive part and are hooked to an inner surface of the through hole, and a terminal that is inserted into the through hole and is electrically connected to the electrode part via the hook parts.

With the arrangement of the window glass electrode leading-out device according to the fifth aspect of the present invention, it is possible to realize an excellent appearance and reduced costs.

To attain the above object, in a sixth aspect of the present invention, there is provided a method of adding conductivity to a window glass that is moved upward and downward by a window regulator, comprising a recess-forming step of forming a recess in an upper end face of the window glass such that the recess has a maximum depth of 0.2 to 5.0 mm and a width of 0.5 to 4.5 mm, and an injecting step of injecting a conductive material into the recess formed in the recess-forming step.

Preferably, the recess-forming step includes grinding the upper end face of the window glass using a diamond wheel having a projecting part, to form the recess.

More preferably, the injecting step includes injecting the conductive material into the recess using a nozzle having a tip end having an inner diameter of 1 to 2 mm.

To attain the above object, in a seventh aspect of the present invention, there is provided a method of adding conductivity to a window glass that is moved upward and downward by a window regulator, comprising a grinding step of grinding an upper end face of the window glass into a generally semi-circular shape, and a mounting step of mounting a covering member formed of a conductive material, as an electrode part, along the upper end face ground into the generally semi-circular shape.

Preferably, the covering member is formed using a roll forming process.

More preferably, the method comprises an electrode forming step of forming an electrode part of a conductive material on the upper end face of the window glass by an inkjet method.

To attain the above object, in an eighth aspect of the present invention, there is provided a method of leading out an electrode from an electrode part formed in/on an upper end face of a window glass that is moved upward and downward by a window regulator, comprising a connecting step of connecting a terminal to the electrode part via a conductive adhesive.

To attain the above object, in a ninth aspect of the present invention, there is provided a method of leading out an electrode from an electrode part formed in/on an upper end face of a window glass that is moved upward and downward by a window regulator, comprising a through hole-forming step of forming a through hole formed through the window glass at a location close to the upper end portion of the window glass, a first electrically connecting step of electrically connecting a clip-shaped part to the electrode part, a hooking step of hooking opposite ends of the clip-shaped part to an inner surface of the through hole, an inserting step of inserting a terminal into the through hole, and a second electrically connecting step of electrically connecting the terminal to the electrode part via the clip-shaped part.

The above and other objects, features, and advantages of the invention will become more apparent from the following detailed description taken in conjunction with the accompanying drawings.

### BRIEF DESCRIPTION OF THE DRAWINGS

FIG. 1 is a schematic view of a window glass according to an embodiment of the present invention.

FIGS. 2A to 2C are cross-sectional views useful in explaining the window glass in FIG. 1, in which FIG. 2A is a view useful in explaining a method of injecting a conductive material into a curved recess formed in an upper end face of the window glass, FIG. 2B is a view useful in explaining a method of forming the curved recess in the upper end face of the window glass; and FIG. 2C is a view useful in explaining another method of forming the curved recess in the upper end face of the window glass.

FIG. 3 is a schematic cross-sectional view of an electrode leading-out device for leading out an electrode from an electrode part appearing in FIG. 2.

FIG. 4 is a schematic view of a variation of the window glass in FIG. 2.

FIG. 5 is a view useful in explaining an inkjet method.

FIG. 6 is a schematic cross-sectional view of a variation of the electrode leading-out device in FIG. 3.

FIG. 7 is a schematic block diagram of a conventional window regulator.

FIG. 8 is a schematic view of a conventional window glass.

FIG. 9 is a schematic view of another conventional window glass.

FIG. 10 is a schematic view of still another conventional window glass.

FIG. 11 is a schematic view of still another conventional window glass.

FIG. 12 is a schematic view of still another conventional window glass.

### DETAILED DESCRIPTION OF THE PREFERRED EMBODIMENTS

The present invention will now be described in detail with reference to the drawings showing a preferred embodiment thereof.

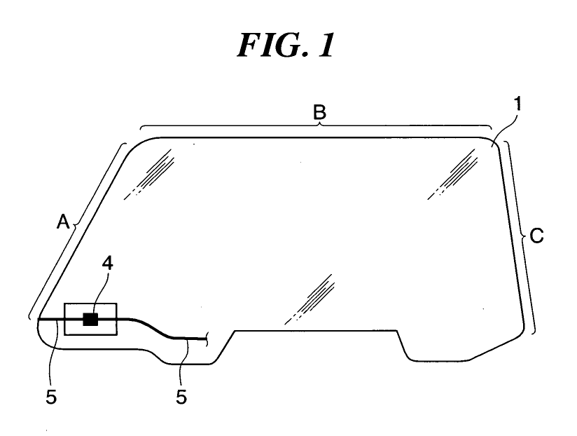

FIG. 1 is a schematic view of a window glass according to an embodiment of the present invention.

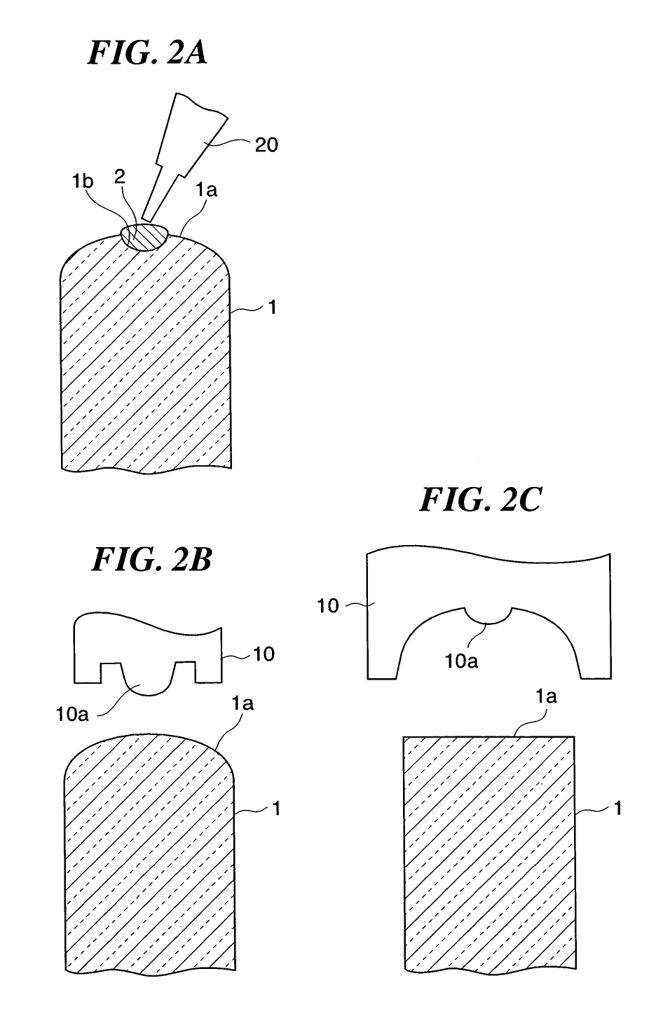

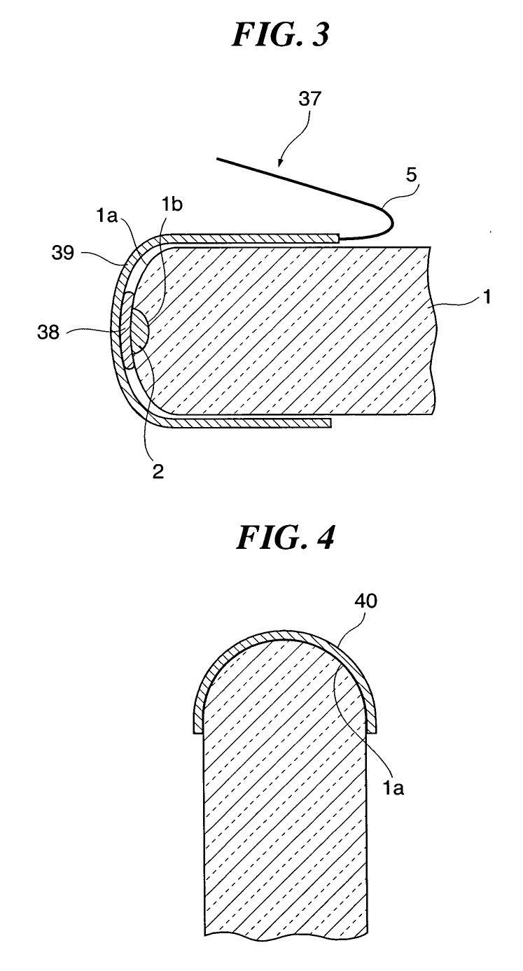

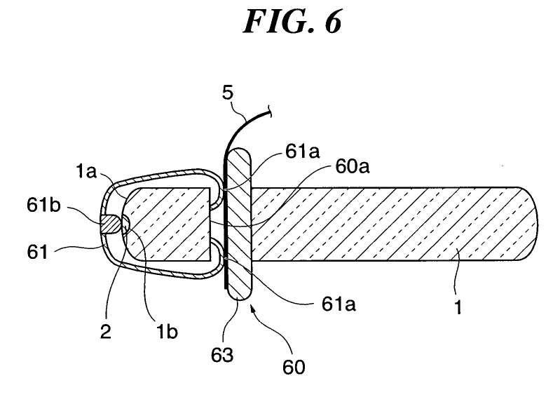

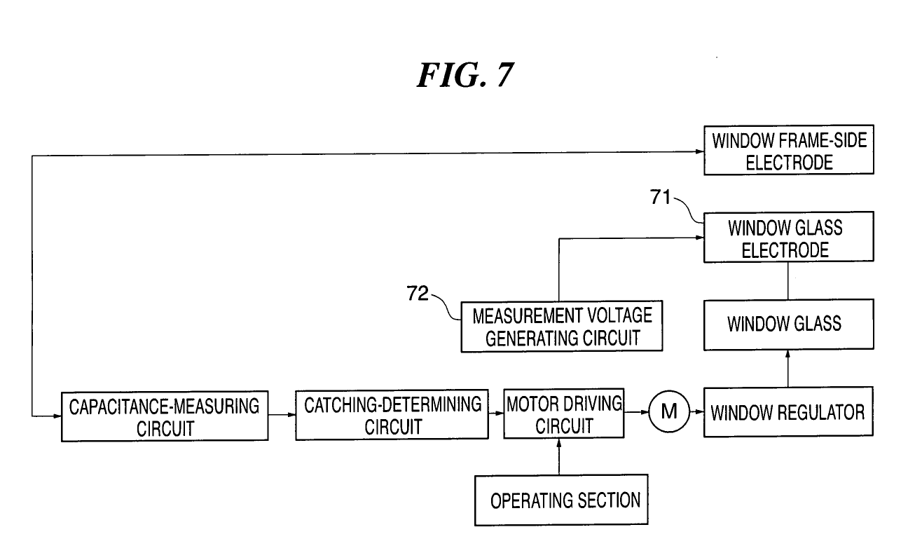

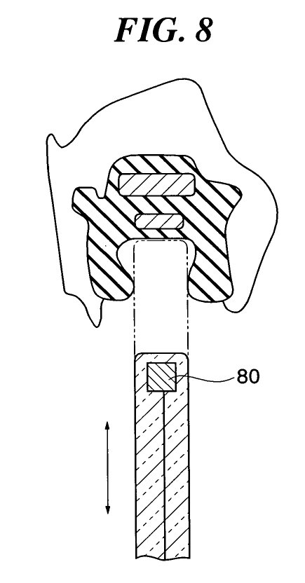

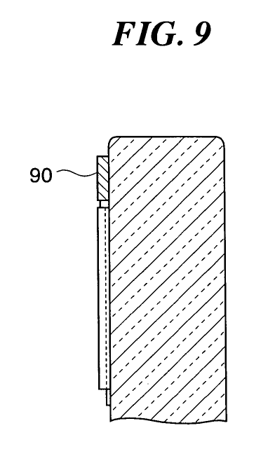

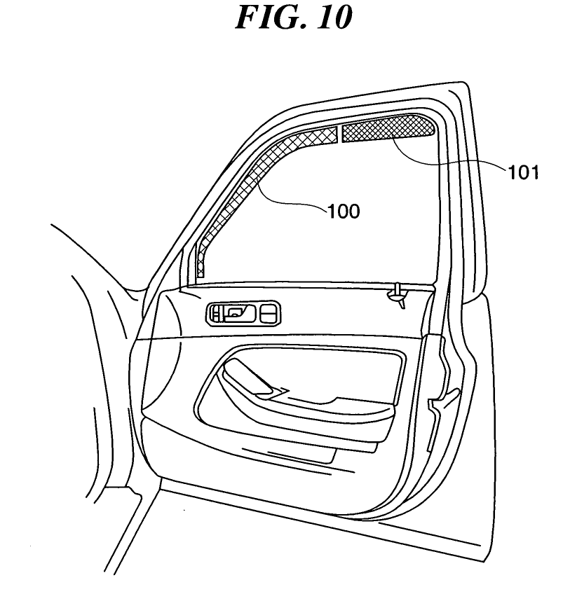

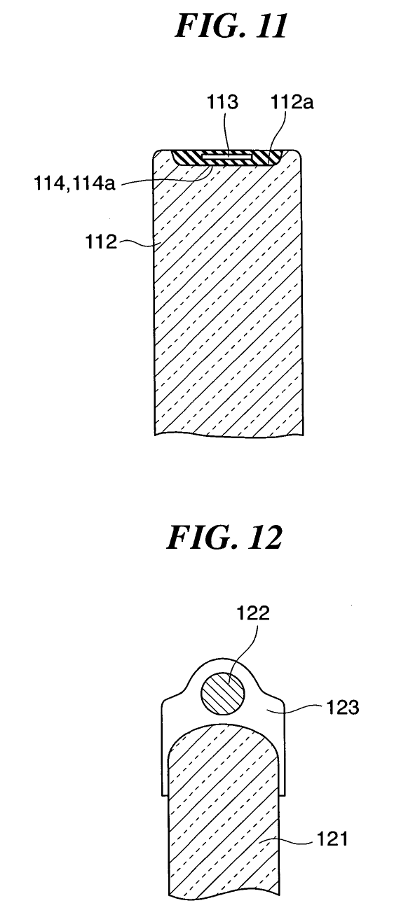

Referring to FIG. 1, the window glass 1 is mounted in a door of a vehicle such that the window glass 1 can be moved upward and downward. The window glass 1 has an electrode part 2, described in detail hereinafter with reference to FIG. 2A, formed in end faces A, B, and C (an upper end face 1a (not shown in FIG. 1)), and a fixed terminal 4 that fixes a lead wire 5 of a conductive terminal 39 (63), described in detail hereinafter with reference to FIGS. 3 and 6, to the window glass 1. The fixed terminal 4 is provided in the vicinity of the end face A or C (i.e. in a portion of the window glass 1, which is not exposed from a door body). In FIG. 1, the fixed terminal 4 is disposed in the vicinity of the end face A.

By fixing the lead wire 5 to the window glass 1 by the fixed terminal 4, it is possible to prevent a tensile force of the lead wire 5, which is generated during vertical movement of the window glass 1, from being applied to the conductive terminal 39 (63).

FIGS. 2A to 2C are cross-sectional views useful in explaining the window glass in FIG. 1. FIG. 2A is a view useful in explaining a method of injecting a conductive material into a curved recess formed in an upper end face of the window glass, and FIGS. 2B and 2C are views useful in explaining respective methods of forming the curved recess in the upper end face of the window glass. Referring to FIG. 2A, the curved recess 1b comprises a groove formed on and along the upper end face 1a of the window glass 1. Thus, the electrode part 2 is formed.

Referring to FIG. 2A, in general, the window glass 1 has a thickness of 2.5 to 6.0 mm. The window glass 1 includes a portion defining the curved recess 1b which is formed in the upper end face 1a such that the curved recess 1b has a maximum depth of 0.2 to 5.0 mm and a width of 0.5 to 4.5 mm, and the electrode part 2 which is formed of a conductive material injected into the curved recess 1b. If the maximum depth of the curved recess 1b is larger than 5.0 mm, or if the width of the curved recess 1b is larger than 4.5 mm, grinding will take time, which causes an increase in manufacturing costs. On the other hand, if the maximum depth of the curved recess 1b is smaller than 0.2 mm, or if the width of the curved recess 1b is smaller than 0.5 mm, it will be difficult to inject the conductive material into the curved recess 1b.

As shown in FIG. 2B, the curved recess 1b is formed in a groove pattern by grinding the upper end face 1a using a diamond wheel 10 having a projecting part 10a. It should be noted that a grinding process for forming the upper end face 1a into a generally semi-circular shape and a grinding process for forming the curved recess 1b may be carried out simultaneously, using the diamond wheel 10′ appearing in FIG. 2C. The window glass 1 is subjected to a heating bending process and an air-cooling reinforcing process after having undergone the grinding process.

The electrode part 2 is formed by injecting the conductive material into the curved recess 1b formed in the upper end face 1a of the window glass 1 from a nozzle 20 (see FIG. 2A) having a tip end formed to have an inner diameter of 1 to 2 mm.

FIG. 3 is a schematic cross-sectional view of an electrode leading-out device for leading out an electrode from the electrode part 2 appearing in FIG. 2.

Referring to FIG. 3, the electrode leading-out device 37 is comprised of the conductive terminal 39 connected, via a conductive adhesive 38, to the electrode part 2 formed in the upper end face 1a of the window glass 1 which is moved upward and downward by a window regulator, and the lead wire 5 connected to one end of the conductive terminal 39.

It should be noted that the electrode leading-out device 37 is disposed in the vicinity of the end face A (see FIG. 1) or C (see FIG. 1) of the upper end face 1a (i.e. in a portion of the upper end face 1a, which is not exposed from the door body). In FIG. 1, the fixed terminal 4 is disposed in the vicinity of the end face A, and hence the electrode leading-out device 37 is also disposed in the vicinity of the end face A.

According to the present embodiment, the curved recess 1b having a maximum depth of 0.2 to 5.0 mm and a width of 0.5 to 4.5 mm is formed in the upper end face 1a, and the conductive material is injected into the curved recess 1b, so that an excellent appearance of the window glass 1 can be realized at low costs.

Further, according to the present embodiment, since the conductive terminal 39 is connected, via the conductive adhesive 38, to the electrode part 2 formed in the upper end face 1a of the window glass 1, an excellent appearance of the window glass 1 can be realized at low costs.

The conductive terminal 39 is formed to have middle portion thereof bent inward such that lateral portions thereof can contact with opposite surfaces of the window glass 1, to sandwich the window glass 1. This makes it possible to mount the conductive terminal 39 more firmly on the window glass 1.

Although in the present embodiment, the electrode part 2 is formed by injecting the conductive material into the curved recess 1b formed in the upper end 1a, this is not limitative, but, as shown in FIG. 4, after the upper end face 1a is ground into a generally semi-circular shape, a covering member 40 as an electrode part made of a conductive material, which is produced e.g. by a roll forming process, may be mounted along the generally semi-circular upper end face 1a (round edge).

Although in the present embodiment, the upper end face 1a is ground using the diamond wheel 10, the shape of the diamond wheel 10 is not limited to a particular shape, but the diamond wheel 10 may have a cup wheel shape or a cylindrical wheel shape, for example.

Although in the present embodiment, the electrode part 2 is formed by injecting the conductive material into the curved recess 1b, this is not limitative, but the electrode part of a conductive material may be formed on an upper end face la without the curved recess 1b by an inkjet method.

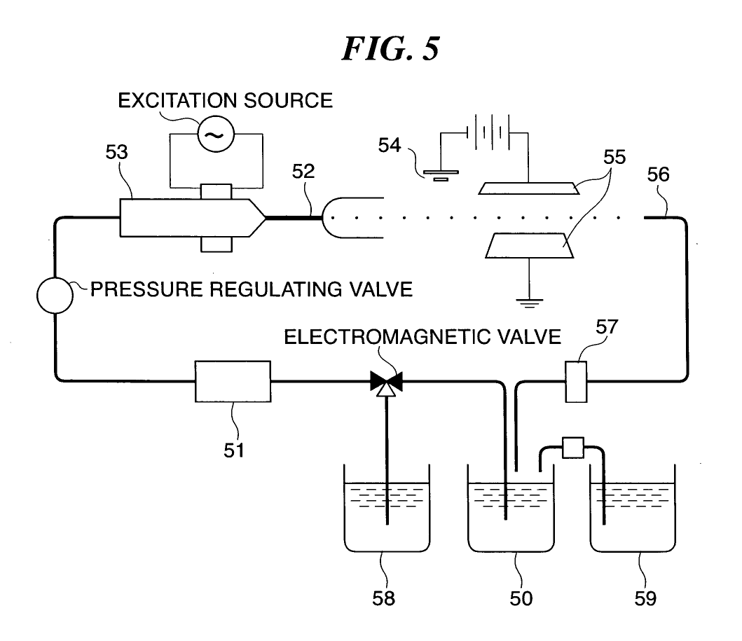

In the inkjet method, generally as shown in FIG. 5, ink in a main bottle 50 is pressurized using a supply pump 51, and is jetted in the form of a liquid column from a nozzle 52. Then, the liquid column is shaken by an electrostrictive element 53 into ink particles each having a predetermined size, and the ink particles are charged, on a particle-by-particle basis, to a predetermined voltage by a charging electrode part 54. While passing through deflecting electrodes 55, the charged ink particles are subjected to deflection corresponding to an amount of electric charge, whereby some of the ink particles reach the upper end face 1a (not shown in FIG. 5). The other ink particles that do not reach the upper end face la are caught by a gutter 56 and are collected in the main bottle 50 by a recovery pump 57. A subsidiary bottle 58 replenishes the main bottle 50 with ink of an amount corresponding to the amount of used ink, and an intensifier bottle 59 replenishes the main bottle 50 with intensifier to maintain ink jetted from the nozzle 52 at a constant concentration.

Although in the present embodiment, as shown in FIG. 3, the electrode part 2 formed in the upper end face 1a of the window glass 1 is connected to the conductive terminal 39 via the conductive adhesive 38, this is not limitative, but the window glass electrode leading-out device may be configured as shown in FIG. 6 by way of example. That is, opposite ends 61a of a conductive clip-shaped part 61 are hooked to an inner surface 60a of a through hole 60 formed in the vicinity of the upper end face 1a of the window glass 1 using a core drill which is a diamond tool, and a conductive terminal 63 is inserted through the through hole 60, such that the conductive clip-shaped part 61 is electrically connected to the electrode part 2 and the conductive terminal 63. It should be noted that the opposite ends 61a have resilience for maintaining excellent connection with the conductive terminal 63. Further, the conductive clip-shaped part 61 has a projecting contact part 61b in contact with the electrode part 2, which is formed at a location opposed to the electrode part 2. The lead wire 5 is connected to the conductive terminal 63.

Although in the present embodiment, the lead wire 5 is fixed to the fixed terminal 4, this is not limitative, but the lead wire 5 is not necessarily required to be fixed to the fixed terminal 4 insofar as the conductive terminal 63 has a sufficient strength for withstanding a tensile force generated in the lead wire 5 during vertical movement of the window glass 1.

What is claimed is:

1. A window glass that is moved upward and downward by a window regulator, comprising:
a portion, defining a recess, that is formed in an upper end face of the window glass such that the recess has a maximum depth of 0.2 to 5.0 mm and a width of 0.5 to 4.5 mm; and
an electrode part that is formed of a conductive material injected into the recess.

2. A window glass according to claim 1, wherein the recess comprises a groove formed on and along the upper end face of the window glass.

3. A window glass according to claim 1, wherein the recess is formed by grinding the upper end face of the window glass using a diamond wheel having a projecting part.

4. A window glass according to claim 1, wherein the conductive material is injected into the recess using a nozzle having a tip end having an inner diameter of 1 to 2 mm.

5. A window glass that is moved upward and downward by a window regulator, the window glass having an upper end face thereof ground into a generally semi-circular shape, comprising:
a covering member that is formed of a conductive material, and is mounted, as an electrode part, along the upper end face ground into the generally semi-circular shape.

6. A window glass according to claim 5, wherein said covering member is formed using a roll forming process.

7. A window glass that is moved upward and downward by a window regulator, comprising:
an electrode part that is formed of a conductive material, said electrode part being formed on an upper end face of the window glass by an inkjet method.

8. A window glass electrode leading-out device for leading out an electrode from an electrode part formed in/on an upper end face of a window glass that is moved upward and downward by a window regulator, comprising:
a terminal that is connected to the electrode part via a conductive adhesive.

9. A window glass electrode leading-out device for leading out an electrode from an electrode part formed in/on an upper end face of a window glass that is moved upward and downward by a window regulator, comprising:
a portion, defining a through hole, that is formed through the window glass at a location close to the upper end portion of the window glass;
a conductive part in a clip shape that is electrically connected to the electrode part;
hook parts which are provided at the opposite ends of said conductive part and are hooked to an inner surface of the through hole; and
a terminal that is inserted into the through hole and is electrically connected to said electrode part via said hook parts.

10. A method of adding conductivity to a window glass that is moved upward and downward by a window regulator, comprising:
a recess-forming step of forming a recess in an upper end face of the window glass such that the recess has a maximum depth of 0.2 to 5.0 mm and a width of 0.5 to 4.5 mm; and
an injecting step of injecting a conductive material into the recess formed in said recess-forming step.

11. A method according to claim 10, wherein said recess-forming step includes grinding the upper end face of the window glass using a diamond wheel having a projecting part, to form the recess.

12. A method according to claim 10, wherein said injecting step includes injecting the conductive material into the recess using a nozzle having a tip end having an inner diameter of 1 to 2 mm.

13. A method of adding conductivity to a window glass that is moved upward and downward by a window regulator, comprising:
a grinding step of grinding an upper end face of the window glass into a generally semi-circular shape; and
a mounting step of mounting a covering member formed of a conductive material, as an electrode part, along the upper end face ground into the generally semi-circular shape.

14. A method according to claim 13, wherein the covering member is formed using a roll forming process.

15. A method according to claim 14, comprising an electrode forming step of forming an electrode part of a conductive material on the upper end face of the window glass by an inkjet method.

16. A method of leading out an electrode from an electrode part formed in/on an upper end face of a window glass that is moved upward and downward by a window regulator, comprising:
a connecting step of connecting a terminal to the electrode part via a conductive adhesive.

17. A method of leading out an electrode from an electrode part formed in/on an upper end face of a window glass that is moved upward and downward by a window regulator, comprising:
a through hole-forming step of forming a through hole formed through the window glass at a location close to the upper end portion of the window glass;
a first electrically connecting step of electrically connecting a clip-shaped part to the electrode part;
a hooking step of hooking opposite ends of the clip-shaped part to an inner surface of the through hole;
an inserting step of inserting a terminal into the through hole; and
a second electrically connecting step of electrically connecting the terminal to the electrode part via the clip-shaped part.
